(19) United States
(12) Patent Application Publication
(10) Pub. No.: US 2026/0116383 A1
(43) Pub. Date: Apr. 30, 2026

(54) SYSTEMS AND METHODS FOR PLANNING LONGITUDINAL PATHS FOR FUTURE CONSTRAINTS

(71) Applicant: Torc Robotics, Inc., Blacksburg, VA (US)

(72) Inventor: Thejus Jose, Austin, TX (US)

(21) Appl. No.: 18/929,111

(22) Filed: Oct. 28, 2024

(51) Int. Cl. B60W 30/14; B60W 50/00; B60W 60/00

(52) U.S. Cl. CPC B60W 30/143; B60W 50/0097; B60W 60/001; B60W 2520/105; B60W 2554/4041; B60W 2554/802

(57) ABSTRACT

Systems and methods for planning longitudinal paths for future constraints autonomous vehicles is provided. The at least one processor of the autonomy computing system is configured to process a future distance constraint between an autonomous vehicle and an object, detect at least one key point in the distance constraint. The key point includes a change in the future distance constraint, compute a velocity corresponding to a jerk minimizing trajectory based on the at least one key point, wherein in the jerk minimizing trajectory, an acceleration of the autonomous vehicle is less than or equal to a maximum allowable deceleration while meeting the future distance constraint. The processor is further configured to initiate a change in velocity of the autonomous vehicle based on the velocity.

### TECHNICAL FIELD

The field of the disclosure relates generally to autonomous vehicles and, more specifically, planning longitudinal paths of an autonomous vehicle.

### BACKGROUND OF THE INVENTION

A trajectory of an autonomous vehicle is generated using a longitudinal planner as the autonomous vehicle travels. The quality of the generated trajectory needs to be closely controlled to provide reliable and efficient operation of the autonomous vehicle. Conventional longitudinal planners are optimized for the shortest duration trajectory before future constraints. The conventional solution is limited in that it cannot process future constraints to the longitudinal path. For example, conventional longitudinal planners are unable to account for changes in constraints at a future time when generating a trajectory. Accordingly, it is desirable to incorporate future constraints to plan longitudinal paths.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a computer-implemented method for planning a longitudinal path of an autonomous vehicle is provided. The computer-implemented method includes processing a future distance constraint of an autonomous vehicle posed by an object, where the future distance constraint is the distance of the object in the future from a position of the autonomous vehicle at a current time. The method also includes detecting at least one key point in the future distance constraint, where the key point includes a change in the future distance constraint. The method also includes computing a velocity corresponding to a jerk minimizing trajectory based on the at least one key point, where in the jerk minimizing trajectory, an acceleration of the autonomous vehicle is less than or equal to a maximum allowable deceleration while meeting the future distance constraint. The method also includes initiating a change in velocity of the autonomous vehicle based on the computed velocity.

In another aspect, an autonomy computing system for an autonomous vehicle is provided. The autonomy computing system includes a memory device storing computer executable instructions. The autonomy computing system also includes a processor coupled to the memory device. The processor, upon executing the computer executable instructions, is programmed to: process a future distance constraint between an autonomous vehicle and an object; detect at least one key point in the future distance constraint, where the key point includes a change in the future distance constraint; compute a velocity corresponding to a jerk minimizing trajectory based on the at least one key point, where in the jerk minimizing trajectory, an acceleration of the autonomous vehicle is less than or equal to a maximum allowable deceleration while meeting the future distance constraint; and initiate a change in velocity of the autonomous vehicle based on the computed velocity.

In yet another aspect, one or more non-transitory machine-readable storage media for planning a longitudinal path of an autonomous vehicle is provided. The non-transitory machine-readable storage media includes a plurality of instructions stored thereon that, in response to being executed, cause a system to process a future distance constraint between an autonomous vehicle and an object, detect at least one key point in the distance constraint, where the key point includes a change in the distance constraint, compute a velocity corresponding to a jerk minimizing trajectory based on the at least one key point. Where in the jerk minimizing trajectory, an acceleration of the autonomous vehicle is less than or equal to a maximum allowable deceleration while meeting the future distance constraint and initiate a change in velocity of the autonomous vehicle based on computed velocity.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3A is a graph representing an example scenario where a traffic vehicle moves in front of an autonomous vehicle from another lane;

FIG. 3B is a graph representing another example scenario where a traffic vehicle cuts through the traffic in front of an autonomous vehicle;

FIG. 3C is a graph representing one more example scenario where a traffic vehicle stops in front of an autonomous vehicle;

FIG. 3D is an example graph representing a candidate point for a key point;

FIG. 3E is another example graph representing a candidate point for a key point;

FIG. 4A is a graph representing an embodiment of determining a minimum deceleration line for at least one key point for an autonomous vehicle;

FIG. 4B is a graph representing an embodiment for determining a longitudinal path for an autonomous vehicle at a position below the minimum deceleration line as shown in FIG. 4A;

FIG. 4C is a graph representing an embodiment for determining a longitudinal path for an autonomous at a position above the minimum deceleration line as shown in FIG. 4A;

FIG. 5 is a flow chart of an example method of planning longitudinal paths for future constraints as shown in FIGS. 1-4; and

FIG. 6 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Systems and methods for planning longitudinal paths to meet future constraints are provided. Because autonomous vehicles rely on path planning for autonomous operation, future constraints should be identified and considered in planning longitudinal paths of the autonomous vehicle. Incorporating future constrains into longitudinal path planning is advantageous in improving autonomous operation because the autonomous vehicle has increased time to respond to the future constraint and avoid jerky operation. In conventional methods of longitudinal path planning, future constraints are not considered. For example, at least some known solutions choose a trajectory that has a reduced duration and ends before an upcoming constraint starts, resulting in a jerky operation of the autonomous vehicle and potential damage to the autonomous vehicle.

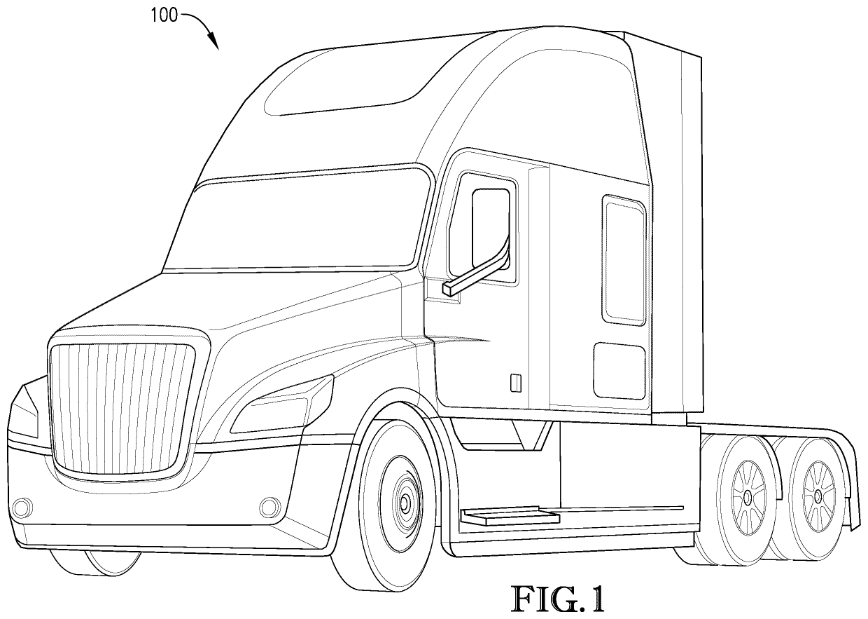

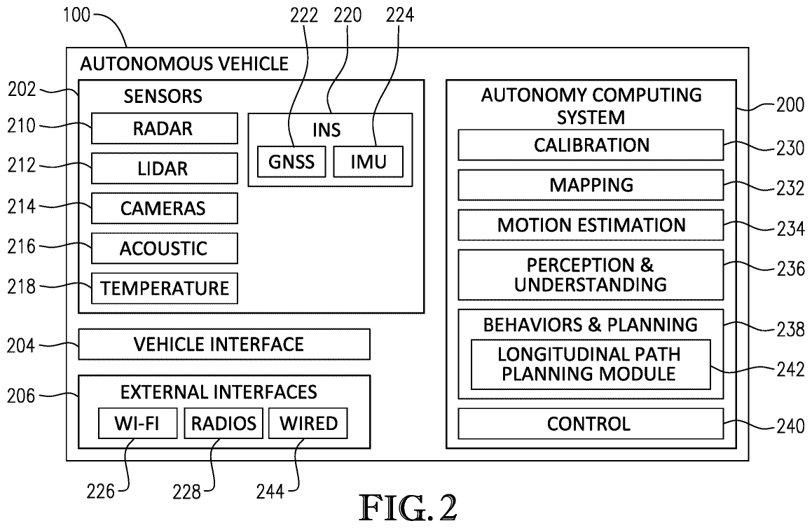

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a longitudinal path planning module 242. longitudinal path planning module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Longitudinal path planning module 242 is configured to maintain the autonomous vehicle 100 within a future distance constraint. The future distance constraint includes constraints from an object in the future placed on the longitudinal path of autonomous vehicle 100. The longitudinal path planning module 242 receives, for example, positions of objects in front of the autonomous vehicle 100 from sensor data and provides future distance constraints based on the positions. The longitudinal path planning module 242 detects changes in the future distance constraint and determines if the point of the detected change is a key point. A key point in the future distance constraint is used in adjusting the longitudinal path of the autonomous vehicle 100. In some embodiments, the detected changes are candidate points, and the longitudinal path planning module 242 determines whether the candidate point is a key point or whether to exclude the candidate point.

When a key point is detected, the longitudinal path planning module 242 computes a velocity for the autonomous vehicle to navigate the key point. The computed velocity may correspond to a jerk minimizing trajectory. The jerk minimizing trajectory is a trajectory along which the least change to the longitudinal path of the autonomous vehicle is demanded. In various embodiments, the computed velocity maintains the acceleration of the autonomous vehicle to be less than or equal to a maximum allowable deceleration. The maximum allowable deceleration limits jerky operation of the autonomous vehicle. Based on the computed velocity, longitudinal path planning module 242 initiates a change in velocity of the autonomous vehicle 100 to navigate the future distance constraint.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

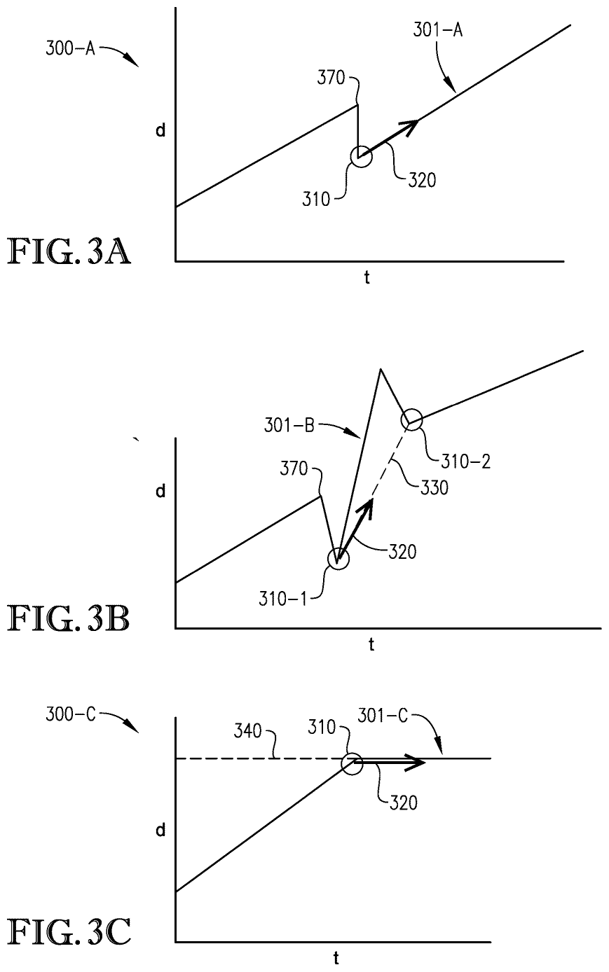

FIGS. 3A-3C are example graphs of a longitudinal distance between an object and autonomous vehicle 100 as a function of time under various scenarios, where the object, such as a traffic vehicle, is the constraint. As used herein, a longitudinal distance between an object and an autonomous vehicle is the distance between the object and the autonomous vehicle along the longitudinal direction of the autonomous vehicle, e.g., the longitudinal axis or the traveling direction of the autonomous vehicle. The reference of the distance depicted in FIGS. 3A-3C is the current location, at the time=0 or the origin of the coordinate system, of the autonomous vehicle 100. Future distance constraints 301 in the graphs represent future constraints, e.g., the location of the traffic vehicle in the future. The travel of the autonomous vehicle 100 in the future is limited by the future distance constraint 301 because the autonomous vehicle 100 should not collide with the object in the future. FIG. 3A is an example graph 300-A showing a scenario where a traffic vehicle cuts in and travels in front of autonomous vehicle 100. The cut-in from the traffic vehicle initially causes a decrease in the future distance constraint 301-A. The future distance constraint 301-A returns to normal as the longitudinal distance between the autonomous vehicle 100 and the traffic vehicle is reestablished. In the example embodiments, the sensor data acquired by sensors 202 are processed by the autonomy computing system 200 (see FIG. 2) to identify a future distance constraint 301-A along a future path of the autonomous vehicle 100. The future distance constraint 301-A corresponds to longitudinal distance values between the autonomous vehicle 100 at the current time (t=0) and an object along the future path at a specific time in the future. For example, a distant constraint 301-A may be determined by estimating the distance in the future of the traffic vehicle from the current position (t=0) of the autonomous vehicle 100 when the traffic vehicle travels along the future path, along which the traffic vehicle cuts in and travels in front of the autonomous vehicle 100.

The longitudinal path planning module 242 processes the future distance constraint 301-A to detect the at least one key point 310. In various embodiments, the key point 310 corresponds to a change in the future distance constraint 301-A. For example, a key point 310 may be a point at which a slope of future distance constraint 301-A changes. Key point 310 indicates changes in future distance constraint 301-A and, therefore, the longitudinal path of autonomous vehicle 100 is adjusted such that the future distance constraint is met at the time t_{keypoint} corresponding to key point 310.

FIG. 3B is a graph 300-B representing distance constraint 301-B for a scenario in which a traffic vehicle cuts through the lane along which autonomous vehicle 100 is traveling and moves to a different lane. Another scenario may include the autonomous vehicle 100 performing automatic cruise control (ACC). The cut-through initially causes a decrease in the future distance constraint 301-B as the traffic vehicle cuts in front of the autonomous vehicle 100, followed by an increase to the future distance constraint 301-B when the traffic vehicle exits the lane of the autonomous vehicle 100. As the traffic vehicle finishes the cut-through and travels along a different lane, the future distance constraint 301-B returns to the slope prior to the traffic vehicle cut-through. In the example embodiment, the longitudinal path planning module 242 detects key points 310 such as, for example, a first key point 310-1 at the time interval when the traffic vehicle cuts into the lane, and a second key point 310-2 when the traffic vehicle exits the lane.

FIG. 3C is a graph 300-C corresponding to a scenario where a traffic vehicle in front of autonomous vehicle 100 stops at a point of time in the future, such as stopping at a stop sign. The longitudinal path planning module 242 processes the future distance constraint 301-C and detects the key point 310.

FIG. 3D and FIG. 3E are graphs representing candidate points 370 that may be ignored by the longitudinal path planning module 242 as key points 310. In various embodiments, to detect a key point 310, the longitudinal path planning module 242 detects a candidate point 370 corresponding to a change in the slope of the future distance constraint 301-C. The longitudinal path planning module 242 determines whether to include or remove the candidate point 370 as a key point 310. For example, a candidate point 370 is removed by the longitudinal path planning module 242 as a key point 310 when the succeeding slope of the future distance constraint 301-C at the candidate point 370 is negative (as shown in FIGS. 3D and 3E), and a preceding slope of the future distance constraint 301-C at the candidate point is positive (as shown in FIG. 3E) or less negative (as shown in FIG. 3D) than the succeeding slope of the future distance constraint 301-C (also see candidate points 370 in FIGS. 3A and 3B that are excluded as key points 310).

In the example embodiments, after the key point 310 is detected, the longitudinal path planning module 242 computes a velocity corresponding to a jerk minimizing trajectory. In various embodiments, the jerk minimizing trajectory includes an acceleration of the autonomous vehicle 100 to meet the future distance constraint 301-C. In some embodiments, the acceleration of the autonomous vehicle 100 to meet the future distance constraint is less than or equal to a maximum allowable deceleration while meeting the future distance constraint.

The longitudinal path planning module 242 processes the future distance constraint 301-C to influence operation of the autonomous vehicle 100. For example, initiating a change in one or more parameters of autonomous vehicle 100, e.g., velocity of the autonomous vehicle 100, based on the computed velocity.

Referring back to FIGS. 3A-3C, longitudinal path planning module 242 is also configured to determine a key point velocity 320 corresponding to a key point 310. Key point velocity 320 at a key point 310 is equal to the slope of the future distance constraint 301 after the key point 310 if the key point 310 is the last key point of future distance constraint 301 (see FIGS. 3A and 3C). In FIG. 3B, the key point 310-1 is not the last key point of future distance constraint 301-B. Key point velocity 320 at key point 310-1 is determined as the slope of a line 330 connecting the current key point 310-1 and the immediately next key point 310-2.

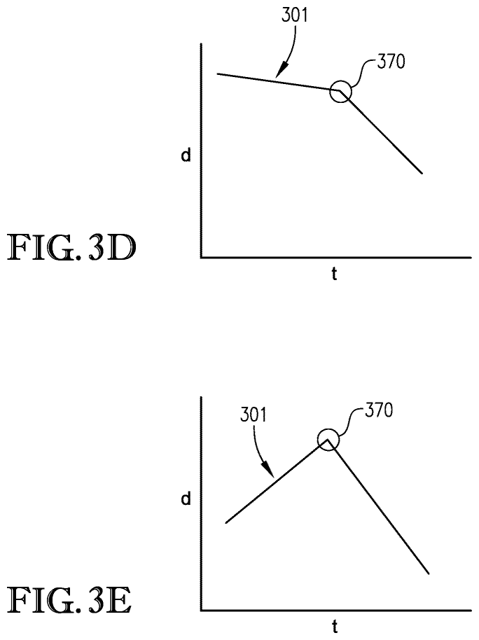

FIGS. 4A-4C are example graphs showing determining a minimum deceleration line 450 based on future distance constraints 401 and planning the longitudinal path of autonomous vehicle 100 based on minimum deceleration line 450. In FIGS. 4A-4C, the reference of the distance d in the y-axis of the graphs is the position of the autonomous vehicle at the current time (t=0) or the origin of the coordinate system. FIG. 4A is a graph 400-A representing an embodiment of determining a minimum deceleration line 450 for the key point 410 of the future distance constraint 401. In various embodiments, the longitudinal path planning module 242 determines a minimum deceleration line 450 based on the key point 410 and the future distance constraint 401. The minimum deceleration line 450 represents the trajectory of the autonomous vehicle 100 with the maximum allowable deceleration limit to reach the future distance constraint at the time corresponding to the key point 410. Minimum deceleration line 450 is determined by backpropagating the trajectory that ends at key point 410 with a slope equal to key point velocity 420 and a deceleration equal to a comfortable deceleration limit. A comfortable deceleration may be one of the specifications of autonomous vehicle 100, and may correspond to a maximum allowable deceleration in normal operation of autonomous vehicle 100, as opposed to emergency maneuvers. The slope at every point on minimum deceleration line 450 represents the maximum velocity autonomous vehicle 100 may take at the corresponding time point such that autonomous vehicle 100 may meet the future distance constraint 401 at the time point corresponding to key point 410 (t=t_{keypoint}) using the comfortable deceleration limit. The longitudinal path planning module 242 determines the computed velocity based on whether the distance of the autonomous vehicle 100 is above or below the minimum deceleration line 450 at an initial time 490.

FIG. 4B is a graph 400-B representing an embodiment for computing a velocity for an autonomous vehicle 100 at a position below a minimum deceleration line 450. When the distance value 480 of the autonomous vehicle 100 at an initial time 490 is below the minimum deceleration line 450, the longitudinal path planning module 242 computes the velocity by setting the maximum allowable deceleration as a predefined deceleration limit. The predefined deceleration limit may be selected as the comfortable deceleration limit of autonomous vehicle 100. When the distance value 480 (dᵢₙᵢₜ) of the autonomous vehicle 100 is below the minimum vehicle deceleration line 450 at the initial time 490 (tᵢₙᵢₜ), the longitudinal path planning module 242 calculates the maximum allowable velocity to reach the future distance constraint 401 at a future time (t_{final}). The maximum allowable velocity (slope 410-ego) at a time point t_{ego} is greater than the slope 420-m of the corresponding point on minimum deceleration line 450 at the same time t_{ego}. When computing the maximum allowable velocity for the initial position (dᵢₙᵢₜ), initial time 490 (tᵢₙᵢₜ) are known. The final velocity (v_{final}) is equal to the key point velocity, which is also equal to the maximum allowable final velocity. The acceleration (a) is equal to the predefined maximum allowable deceleration. The predefined maximum allowable deceleration may be equal to the comfortable deceleration limit. Further, the final position (d_{final}) located along the future distance constraint 401 after the key point 410, where d_{final}=d_{keypoint}+v_{keypoint}*(t_{final}−t_{keypoint}). The remaining unknowns are final time (t_{final}) and initial velocity (vᵢₙᵢₜ). Using equations of motion, two values for final time (t_{final}) are calculated, as shown below:

$${v}_{final} = {v}_{init} + a * ( {t}_{final} - {t}_{init} ) \to {v}_{init} = {v}_{final} - a * ( {t}_{final} - {t}_{init} ) \qquad ( 1 )$$

$$( 2 )$$

$$( {d}_{final} - {d}_{init} ) = {v}_{init} * ( {t}_{final} - {t}_{init} ) + \frac{a}{2} * {( {t}_{final} - {t}_{init} )}^{2} \to {v}_{i n i 𝔱} = \frac{[ ( {d}_{final} - {d}_{i n i 𝔱} ) - \frac{a}{2} * {( {t}_{final} - {t}_{init} )}^{2} ]}{( {t}_{final} - {t}_{init} )} \to {v}_{i n i 𝔱} = \frac{\begin{matrix}[ \{ ( {d}_{k e y p o i n 𝔱} + {v}_{k e y p o i n 𝔱} * ( {t}_{final} - {t}_{k e y p o i n 𝔱} ) ) - {d}_{init} \} - \\ ( \frac{a}{2} ) * {( {t}_{final} - {t}_{init} )}^{2} ]\end{matrix}}{( {t}_{final} - {t}_{init} )}$$

$$Equating Eqns . ( 1 ) and ( 2 ) , the following equation is derived :$$

$$( - \frac{a}{2} ) * {( {t}_{final} )}^{2} + ( a * {t}_{init} ) * ( {t}_{final} ) + [ - a * \frac{{( {t}_{i n i t} )}^{2}}{2} - ( {v}_{final} ) * ( {t}_{init} ) - {d}_{keypoint} + {v}_{keypoint} * {t}_{keypoint} + {d}_{init} ] = 0 \qquad ( 3 )$$

Solving Eqn. (3), the two values for final time (t_{final}) are derived. The smaller of the two values that is greater than initial time (tᵢₙᵢₜ) value is selected as the final time (t_{final}), because the final time point is later than the initial time point and the smaller time point indicates reaching the final time point sooner. Once the final time (t_{final}) is determined, the initial velocity (vᵢₙᵢₜ) may be determined based on Eqn. (1). The longitudinal path for autonomous vehicle 100 is computed using velocities from the initial time (tᵢₙᵢₜ) to the final time (t_{final}). Accordingly, the computed velocity includes velocities at time points during the time period. The longitudinal path planning module 242 then initiates a change in velocity for the autonomous vehicle 100 based on the computed velocity. With the computed velocity, longitudinal path 430 of autonomous vehicle 100 is derived. Autonomous vehicle 100 may travel along longitudinal path 430.

FIG. 4C is a graph 400-C representing an embodiment for computing a velocity when a distance of autonomous vehicle 100 is above a minimum deceleration line 450 at an initial time 490. When the distance value 480 of the autonomous vehicle 100 at an initial time 490 is above the minimum deceleration line 450, the longitudinal path planning module 242 computes the velocity for the longitudinal path to navigate the future distance constraint 401 based on the key point 410. The maximum allowable velocity at a time point t_{ego} is smaller than the slope 420-m of the corresponding point on minimum deceleration line 450 at the same time t_{ego}. Ego refers to autonomous vehicle 100. In the example embodiment, the longitudinal path planning module 242 computes the maximum allowable velocity to determine the longitudinal path, where d_{final} and t_{final} of autonomous vehicle 100 is equal to the distance and time at key point 410, d_{final}=d_{keypoint} and t_{final}=t_{keypoint}. Because minimum deceleration line 450 corresponds to a comfortable deceleration limit, when the distance of autonomous vehicle 100 at an initial time point 490 is above minimum deceleration line 450, the maximum deceleration of autonomous vehicle 100 should not be the comfortable deceleration limit. Otherwise, if the maximum deceleration is set as the comfortable deceleration, at a certain distance d_{ego} at a certain t_{ego}, velocity of autonomous vehicle 100 will be negative, which is inapplicable in real world. Based on the future distance constraint 401 and the key point 410, the longitudinal path planning module 242 computes the maximum allowable deceleration. The maximum allowable deceleration continues reducing until the longitudinal path 430 of autonomous vehicle 100 reaches key point 410, where d_{ego}=d_{keypoint}. vᵢₙᵢₜ and v_{final} may be expressed in terms of acceleration (a) as follows:

$${v}_{final} - {v}_{init} = a * ( {t}_{final} - {t}_{init} ) ; and \qquad ( 4 )$$

$${( {v}_{final} )}^{2} - {( {v}_{init} )}^{2} = 2 * a * ( {d}_{final} - {d}_{init} ) \to ( {v}_{final} - {v}_{init} ) * ( {v}_{final} + {v}_{init} ) = 2 * a * ( {d}_{final} - {d}_{init} ) . \qquad ( 5 )$$

Solving Eqns. (4) and (5), vᵢₙᵢₜ and v_{final} may be derived as:

$${v}_{init} = \frac{( {d}_{final} - {d}_{i n i t} )}{( {t}_{final} - {t}_{i n i t} )} - \frac{a}{2} * ( {t}_{final} - {t}_{init} ) ; \qquad ( 6 )$$

$${v}_{final} = \frac{( {d}_{final} - {d}_{i n i t} )}{( {t}_{final} - {t}_{init} )} + \frac{a}{2} * ( {t}_{final} - {t}_{init} ) . \qquad ( 7 )$$

Because 0<vᵢₙᵢₜ<∞, and 0<vᵢₙᵢₜ<v_{keypoint}, substituting vᵢₙᵢₜ and v_{final} in the inequalities with Eqns. (6) and (7), a maximum acceleration and a minimum acceleration are derived. The minimum acceleration corresponds to the maximum deceleration. The maximum deceleration is:

$$a = max ( comfortable deceleration limit , - 2 * \frac{( {d}_{final} - {d}_{init} )}{{( {t}_{final} - {t}_{init} )}^{2}} ) .$$

Based on the maximum deceleration, to meet the future distance constraint 401 the computed velocity of autonomous vehicle 100 is derived. For example, the computed velocity is determined based on the derived maximum deceleration using Eqn. (6). The longitudinal path planning module 242 utilizes the computed velocity to initiate a change in the velocity of the autonomous vehicle 100. With the computed velocity, longitudinal path 430 of autonomous vehicle 100 is derived. Autonomous vehicle 100 may travel along longitudinal path 430.

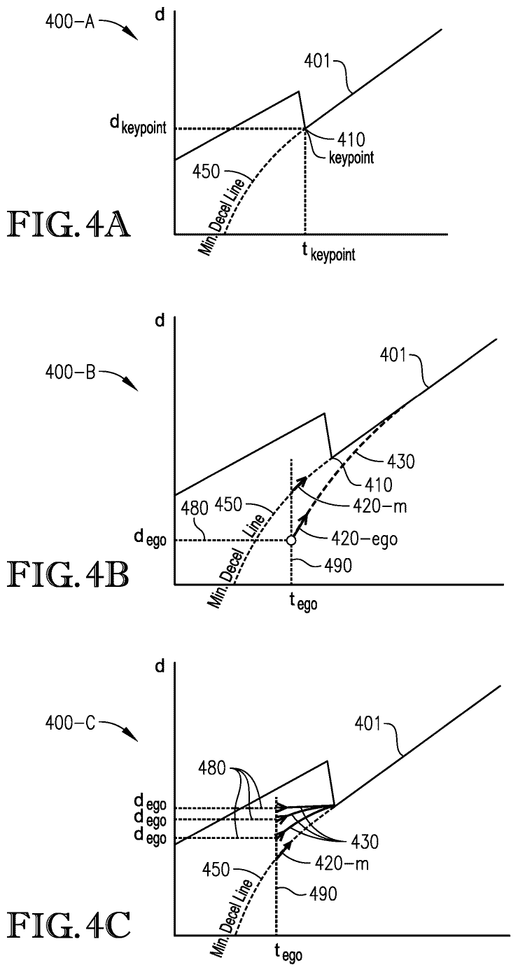

FIG. 5 is a flow chart of method 500 of planning longitudinal paths for future constraints. Method 500 may be implemented by autonomy computing system 200 of autonomous vehicle 100. In the example embodiment, method 500 includes processing 510 a future distance constraint between an autonomous vehicle and an object. Method 500 also includes detecting 520 the key point in the future distance constraint. Detecting 520 the candidate point further includes detecting a candidate point in the future distance constraint, wherein a slope at the candidate point changes and including the candidate point into the key point. Additionally, or alternatively, detecting 520 the key point further includes removing the candidate point from the key point, wherein a succeeding slope at the candidate point is negative, and a preceding slope at the candidate point is positive or less negative than the succeeding slope. The key point includes a change in the future distance constraint. Method 500 further includes computing 530 a velocity corresponding to a jerk minimizing trajectory based on the key point, wherein in the jerk minimizing trajectory, an acceleration of the autonomous vehicle 100 is less than or equal to a maximum allowable deceleration while meeting the future distance constraint. Method 500 further includes initiating 540 a change in velocity of the autonomous vehicle 100 based on the computed velocity.

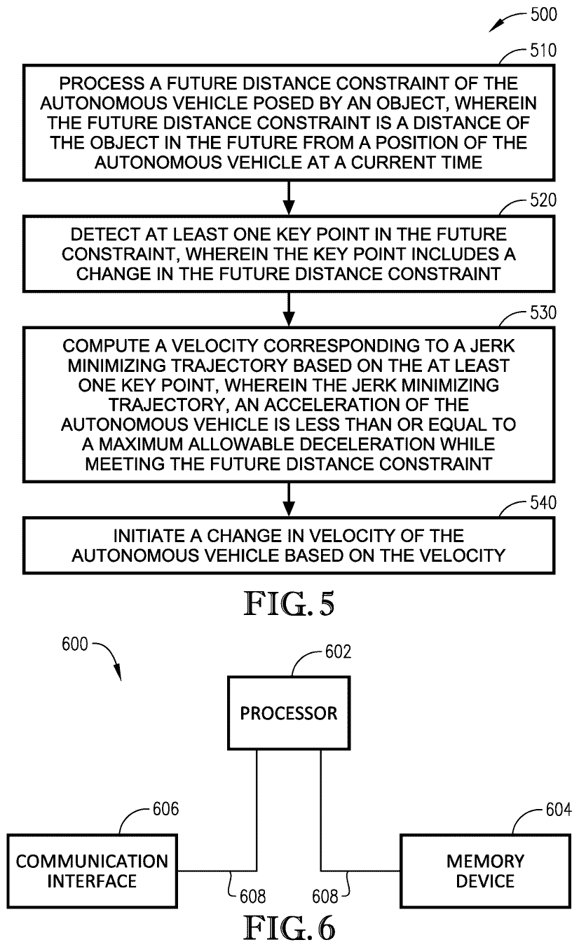

FIG. 6 is a block diagram of an example computing device 600. Autonomy computing system 200 may be implemented with one or more computing device 600. Computing device 600 includes a processor 602 and a memory device 604. The processor 602 is coupled to the memory device 604 via a system bus 608. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 604 includes one or more devices that enable information, such as executable instructions or other data (e.g., sensor data), to be stored and retrieved. Moreover, the memory device 604 includes one or more computer readable media, such as, without limitation, dynamic random access memory (DRAM), static random access memory (SRAM), a solid state disk, or a hard disk. In the example embodiment, the memory device 604 stores, without limitation, application source code, application object code, configuration data, additional input events, application states, assertion statements, validation results, or any other type of data. The computing device 600, in the example embodiment, may also include a communication interface 606 that is coupled to the processor 602 via system bus 608. Moreover, the communication interface 606 is communicatively coupled to data acquisition devices.

In the example embodiment, processor 602 may be programmed by encoding an operation using one or more executable instructions and providing the executable instructions in the memory device 604. In the example embodiment, the processor 602 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) increased longitudinal path planning capabilities and reducing jerky driving during autonomous operation, or (b) using key points in the future distance constraint in determining the computed velocity of the autonomous vehicle.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A computer-implemented method for planning a longitudinal path of an autonomous vehicle, the method comprising:
processing a future distance constraint of an autonomous vehicle posed by an object, wherein the future distance constraint is a distance of the object in the future from a position of the autonomous vehicle at a current time;
detecting at least one key point in the future distance constraint, wherein the key point includes a change in the future distance constraint;
computing a velocity corresponding to a jerk minimizing trajectory based on the at least one key point, wherein in the jerk minimizing trajectory, an acceleration of the autonomous vehicle is less than or equal to a maximum allowable deceleration while meeting the future distance constraint; and
initiating a change in velocity of the autonomous vehicle based on the velocity.

2. The method of claim 1, wherein detecting the at least one key point further comprises:
detecting a candidate point in the future distance constraint, wherein a slope at the candidate point changes; and
including the candidate point into the at least one key point.

3. The method of claim 2, wherein detecting the at least one key point further comprises:
removing the candidate point from the at least one key point, wherein a succeeding slope at the candidate point is negative, and a preceding slope at the candidate point is positive or less negative than the succeeding slope.

4. The method of claim 1, wherein computing the velocity further comprises:
determining a minimum deceleration line based on the at least one key point and the future distance constraint.

5. The method of claim 4, wherein computing the velocity further comprises:
setting the maximum allowable deceleration as a predefined deceleration limit if a distance of the autonomous vehicle is at or below the minimum deceleration line at an initial time point.

6. The method of claim 4, wherein computing the velocity further comprises:
reducing the maximum allowable deceleration until a distance of the autonomous vehicle is equal to a distance at the at least one key point at a future time point corresponding to the at least one key point if a distance of the autonomous vehicle at an initial time point is above the minimum deceleration line.

7. The method of claim 1 further comprising detecting an additional key point in the future distance constraint; and computing the velocity further comprises:
modifying the velocity based on the additional key point.

8. An autonomy computing system for an autonomous vehicle, the autonomy computing system comprising:
a memory device storing computer executable instructions; and
a processor coupled to the memory device, the processor, upon executing the computer executable instructions, configured to:
process a future distance constraint of the autonomous vehicle posed by an object, wherein the future distance constraint is a distance of the object in the future from a position of the autonomous vehicle at a current time;
detect at least one key point in the future distance constraint, wherein the key point includes a change in the future distance constraint;
compute a velocity corresponding to a jerk minimizing trajectory based on the at least one key point, wherein in the jerk minimizing trajectory, an acceleration of the autonomous vehicle is less than or equal to a maximum allowable deceleration while meeting the future distance constraint; and
initiate a change in velocity of the autonomous vehicle based on the velocity.

9. The autonomy computing system of claim 8, wherein the processor is further configured to:
detect a candidate point in the future distance constraint, wherein a slope at the candidate point changes; and
include the candidate point into the at least one key point.

10. The autonomy computing system of claim 9, wherein the processor is further configured to:
remove the candidate point from the at least one key point, wherein a succeeding slope at the candidate point is negative, and a preceding slope at the candidate point is positive or less negative than the succeeding slope.

11. The autonomy computing system of claim 8, wherein the processor is further configured to:
determine a minimum deceleration line based on the at least one key point and the future distance constraint.

12. The autonomy computing system of claim 11, wherein the processor is further configured to:
set the maximum allowable deceleration as a predefined deceleration limit if a distance of the autonomous vehicle is at or below the minimum deceleration line at an initial time point; and
compute the velocity based on the maximum allowable deceleration.

13. The autonomy computing system of claim 11, wherein the processor is further configured to:
reduce the maximum allowable deceleration until a distance of the autonomous is equal to a distance at the at least one key point at a future time point corresponding to the at least one key point if a distance of the autonomous vehicle at an initial time point is above the minimum deceleration line; and
compute the velocity based on the maximum allowable deceleration.

14. The autonomy computing system of claim 8, wherein the processor is further configured to:
detect an additional key point in the future distance constraint; and
modify the velocity based on the additional key point.

15. One or more non-transitory machine-readable storage media for planning a longitudinal path of an autonomous vehicle, comprising a plurality of instructions stored thereon that, in response to being executed, cause a system to:
process a future distance constraint of an autonomous vehicle posed by an object, wherein the future distance constraint is a distance of the object in the future from a position of the autonomous vehicle at a current time;
detect at least one key point in the future distance constraint, wherein the key point includes a change in the future distance constraint;
compute a velocity corresponding to a jerk minimizing trajectory based on the at least one key point, wherein in the jerk minimizing trajectory, an acceleration of the autonomous vehicle is less than or equal to a maximum allowable deceleration while meeting the future distance constraint; and
initiate a change in velocity of the autonomous vehicle based on the velocity.

16. The one or more non-transitory machine-readable storage media of claim 15,
wherein the plurality of instructions further cause the system to:
detect a candidate point in the future distance constraint, wherein a slope at the candidate point changes; and
detect the at least one key point corresponding to the candidate point.

17. The autonomous vehicle of claim 16, wherein the autonomy computing system is further configured to:
remove the candidate point from the at least one key point, wherein a succeeding slope at the candidate point is negative, and a preceding slope at the candidate point is positive or less negative than the succeeding slope.

18. The autonomous vehicle of claim 15, wherein the autonomy computing system is further configured to:
determine a minimum deceleration line based on the at least one key point and the future distance constraint to compute the velocity.

19. The autonomous vehicle of claim 15, wherein the autonomy computing system is further configured
set the maximum allowable deceleration as a predefined deceleration limit if a distance of the autonomous vehicle is at or below the minimum deceleration line at an initial time point; and
compute the velocity with the maximum allowable deceleration.

20. The autonomous vehicle of claim 19, wherein the autonomy computing system is further configured to:
reduce the maximum allowable deceleration until a distance of the autonomous is equal to a distance at the at least one key point at a future time point corresponding to the at least one key point if a distance of the autonomous vehicle at an initial time point is above the minimum deceleration line; and
compute the velocity with the distance at the at least one key point at the future time point.
